(19) United States
(12) Patent Application Publication
(10) Pub. No.: US 2021/0049291 A1
(43) Pub. Date: Feb. 18, 2021

(54) Securing Display of Sensitive Content from Ambient Interception

(71) Applicant: Caleb Sima, San Francisco, CA (US)

(72) Inventor: Caleb Sima, San Francisco, CA (US)

(21) Appl. No.: 16/991,944

(22) Filed: Aug. 12, 2020

Related U.S. Application Data
(60) Provisional application No. 62/886,188, filed on Aug. 13, 2019.

(51) Int. Cl. G06F 21/62; G06K 9/00; H04N 7/18; G06K 9/62; G06F 21/60; G06N 20/00; G07C 9/00

(52) U.S. Cl. CPC G06F 21/6218; G06K 9/00228; G06K 9/00771; H04N 7/188; G07C 9/00896; G06K 9/00335; G06F 21/604; G06N 20/00; G06K 9/6256

(57) ABSTRACT

A system described herein is configured to receive an image of a field of view from which a display screen can be observed. The image is captured while the display screen presents sensitive content. The system then determines that the image depicts a viewer or act not authorized for the sensitive content and, in response, initiates a security action. Additionally, the system may determine that a received image depicts a lack of viewer engagement with displayed content and, in response, may initiate an action to ensure viewer engagement with the content.

### PRIORITY APPLICATION

This patent application claims priority to U.S. provisional patent application No. 62/886,188, filed on Aug. 13, 2019. Application No. 62/886,188 is hereby incorporated by reference, in its entirety.

### BACKGROUND

With electronic content increasingly replacing paper or in-person presentations, sensitive content (e.g., financial disclosures) and educational content (e.g., continuing education courses) are often presented to users via a display screen. With this change, it is often easier for an unauthorized viewer to see the sensitive content or for an unauthorized viewer to, e.g., capture an image of the content. These possibilities reduce the security desirable for such content. It is also easier for a viewer to disengage with an electronically-displayed presentation than it would be, for instance, with an in-person version of that presentation.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an overview of a system including a computing device, a camera, and a display screen presenting sensitive content or other content, and viewers and other devices capable of observing or interacting with the content.

FIG. 2 illustrates a component level view of a computing device configured with components for capturing and evaluating images of a field of view from which a display screen can be observed and for evaluating the images for unauthorized interactions with sensitive content display on the display screen.

FIG. 3 illustrates an example process for determining, based on an image, that an unauthorized viewer has observed sensitive content displayed on a display screen or an unauthorized act has occurred with respect to the sensitive content and, in response, initiating a security action.

FIG. 4 illustrates an example process for determining, based on an image, that a viewer is not engaged with displayed content and taking an action to ensure viewer engagement.

### DETAILED DESCRIPTION

Described herein is a system configured to receive an image of a field of view from which a display screen can be observed. The image is captured while the display screen presents sensitive content. The computing device then determines that the image depicts a viewer or act not authorized for the sensitive content and, in response, initiates a security action. Additionally, the computing device may determine that a received image depicts a lack of viewer engagement with displayed content and, in response, may initiate an action to ensure viewer engagement with the content.

In some examples, the computing device may be a system that makes use of the front facing camera in a device and detects whether a user tries to take a photo of the screen or identifies if multiple people are looking at the monitor. Such detection may ensure that the user that is supposed to be viewing the sensitive content on the screen is alone and does not try to take photos of the screen. If the system detects that a user is taking a photo or multiple people are viewing the monitor, then an alert is generated and sent to, e.g., the backend to signify that a violation has taken place. In other examples, the camera and monitor may be or belong to different devices, the computing device may be remote from both the monitor and the camera, the above-described operations may be distributed across multiple computing devices, etc.

### Overview

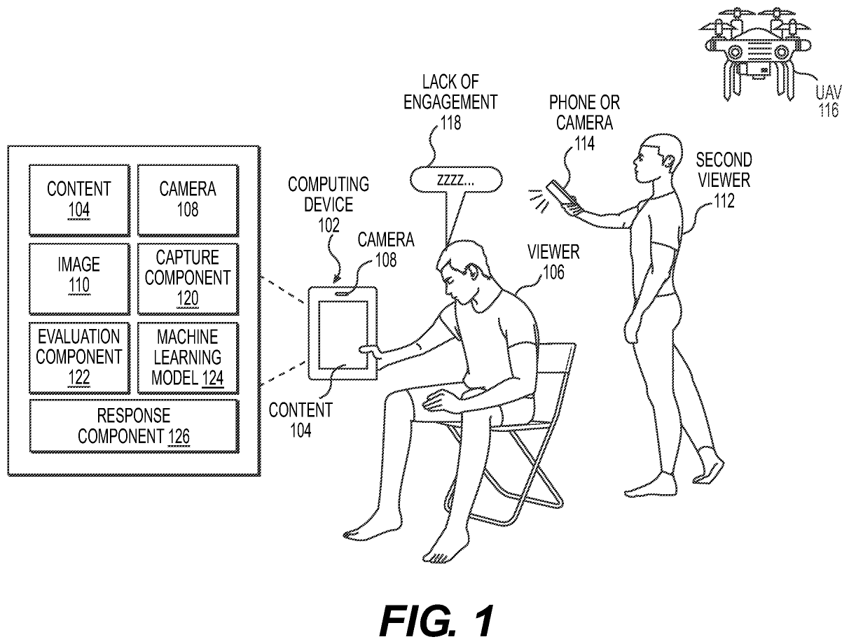

FIG. 1 illustrates an overview of a system including a computing device, a camera, and a display screen presenting sensitive content or other content, and viewers and other devices capable of observing or interacting with the content. As illustrated, a computing device 102 may present content 104, such as sensitive content, to a viewer 106. A camera 108 of the computing device 102 may capture an image 110 of a field of view from which the display screen of the computing device 102 can be seen. While the computing device 102 presents the content 104, a number of events can occur, such as a second viewer 112 observing the content 104, a phone or camera 114 capturing an image of the display screen of the computing device 102 while it displays the content 104, a UAV 116 capturing such an image, or a lack of engagement 118 on the part of the viewer 106. The computing device 102 may be equipped with components to detect the occurrence of any of these events within the image 110, such an a capture component 120 for receiving the image 110, an evaluation component 122 for evaluating the image 110, a machine learning model 124 for use by the evaluation component 122, and a response component 126 for taking action based on a result of the evaluation.

While FIG. 1 illustrates computing device 102 as a local device displaying content 104 and including a camera 108, it is to be understood that the computing device 102 may instead be remote from a display screen presenting the content 104 and from camera 108 or may represent multiple computing devices which the content 104, image 110, capture component 120, evaluation component 122, machine learning model 124, and/or response component 126 may be distributed among.

Further, while FIG. 1 shows the second viewer 112 as standing behind the viewer 106, it is to be understood that the second viewer 112 may be sitting (e.g., at a desk behind the viewer 106) or may be in any other position that has or may have a line of sight to the display screen presenting the content 104. Further, the viewer 106 may also or instead hold the camera or phone 114; the camera or phone 114 may be held by any person or device so long as the camera or phone 114 has or may have a line of sight to the display screen presenting the content 104. Likewise, the UAV 116 may be in any position that has or may have a line of sight to the display screen presenting the content 104.

In various implementations, the computing device 102 may be any sort of computing device, such as a mobile telecommunication device, a tablet computer, a personal computer, a laptop computer, a desktop computer, a workstation computer, an electronic reading device, a media playing/gaming device, etc. The computing device 102 includes or is connected to (locally or remotely) a monitor or display screen capable of presenting content 104 (e.g., sensitive content, education content, etc.) and also includes or is connected to (locally or remotely) a camera 108 (e.g., a front-facing camera, a peripheral camera, etc.).

In some implementations, one or more cameras 108 of the computing device 102, whether peripheral or integrated, may capture images 110 on a periodic or event-driven basis. As used herein, “images” 110 may include both still images 110 and videos 110 captured by any one or more cameras 108. These images 110 may then be exposed by the computing device 102 through, for example, an application programming interface (API) to applications or components of the device, such as the capture component 120 (also referred to herein as “applications or components 120” and “application or component 120”). Such applications or components 120 may be part of a platform or operating system (OS) of the computing device 102 or may be third party applications. In further implementations, the applications or components may include a remote application or component, such as a remote service (not shown in FIG. 1). In other embodiments, an application or component 120 may request an image 110 capture through the API and receive an image 110 in response. For example, the application or component 120 may be notified that sensitive content 104 is being displayed and may, in response, request image 110 capture.

Upon receiving an image 110, an application or component, such as evaluation component 122 (also referred to herein as “application or component 122”), may utilize a machine learning model 124 to analyze the image 110 and determine whether the image 110 depicts an image capture of a monitor or display screen of the computing device 102 (e.g., by a camera or phone 114) or depicts multiple faces looking at the monitor or display screen of the computing device 102 (e.g., such as the viewer 106 and second viewer 112). Such machine learning models 124 may be trained with a corpus of images 110 that depict image capture or multiple faces, as well as images 110 that include neither of these things (e.g., images 110 that don't include a user, images 110 with a single user not holding an image capturing device, images with a second user some distance from the monitor or screen and looking in a different direction, etc.). In some implementations, confidence thresholds of the machine learning model 124 may be tunable by a user of the device or by developers or information technology professionals responsible for developing and maintaining the application or component 122 and/or the machine learning model 124. Additionally, a training set of images 110 may be updated from time to time, resulting in updates to the machine learning model 124. Also, in some implementations, the determination may make reference to other input sources, such as a microphone of the computing device 102, and may analyze a text-to-speech translation of the microphone data for, e.g., specific keywords.

In various implementations, a determination that an image capture has occurred or that multiple faces have looked at the screen or monitor may result in one or more actions by an application or component, such as the response component 126 (also referred to herein as “application or component 126”). The application or component 126 may, for example, cause the screen or monitor to be turned off, to display alternative content, to close a window displaying sensitive content 104, etc. The application or component 126 may also or instead cause an alert to be sent to an owner of the sensitive content 104, to an entity (e.g., a company) that employs the user or the sensitive content owner, or to any other person or entity to enable action to be taken. For example, security personnel may be deployed or actions locking one or more doors may be taken. Additionally, the application or component 126 may cause the computing device 102 to capture any available information about other device(s) in proximity, such as a device 114 that captured the display of the screen or monitor or a device 114 of a second user (e.g., second viewer 114). Such information could include any network information, such as a mobile station international subscriber directory number (MSISDN), of such other device(s) 114.

In addition to user image capture of the monitor or screen or viewing by multiple users, the application or component 122 may also utilize the machine learning model 124 to identify other types of ambient interception, such as the presence of an unmanned aerial vehicle (UAV) 116 in an image 110.

In addition or instead, the application or component 122 may utilize the machine learning model 124 to analyze the image 110 and determine whether the image depicts a lack of viewer engagement 118 (e.g., user looking away from the monitor or display screen of the computing device 102). Such a determination may aid in ascertaining whether the user, such as viewer 106 (also referred to herein as “user 106”) has in fact viewed sensitive content 104. Following such a determination, an alert may, e.g., be displayed to the user 106 and the user 106 may not be enabled to move on to further content, may be required to answer one or more questions about the content, etc. Such a determination may also help detect if the user 106 is paying attention. If the user 106 is not paying attention (e.g. is not engaged 118), then alerts/actions may be generated. Such alerts/actions can include sending a notification to backend, removing the sensitive content 104, or deciding that the user 106 is no longer around. This could also be used to determine during online tests whether the user 106 could be referencing other material or doing something besides being focused on the content 104 at displayed on the monitor or screen.

### Example System

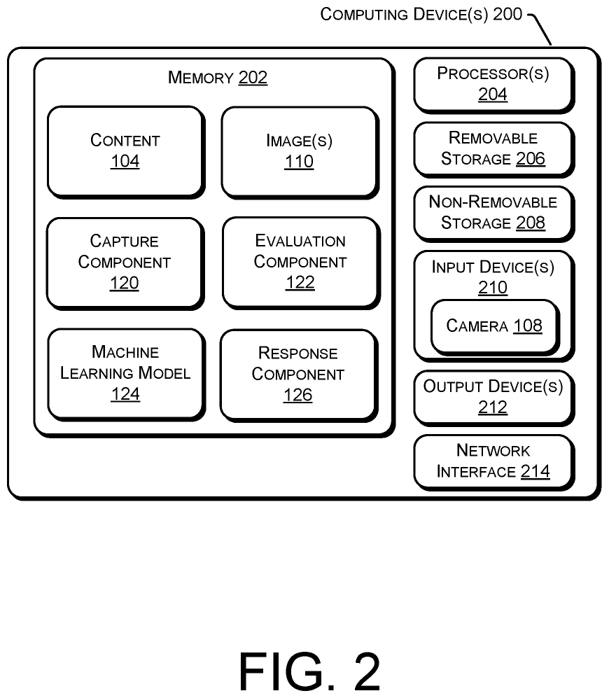

FIG. 2 illustrates a component level view of a computing device configured with components for capturing and evaluating images of a field of view from which a display screen can be observed and for evaluating the images for unauthorized interactions with sensitive content display on the display screen. As illustrated, computing device 200 comprises a memory 202 storing content 104, image(s) 110, a capture component 120, an evaluation component 122, a machine learning model 124, and a response component 126. Also, computing device 200 includes processor(s) 204, a removable storage 206 and non-removable storage 208, input device(s) 210 (including camera 108), output device(s) 212, and network interface(s) 214.

The computing device 200 may be an example of a computing device 102, may be another, remote computing device configured with one or more of the content 104, image(s) 110, the capture component 120, the evaluation component 122, the machine learning model 124, or the response component 126, or may be any combination of the computing device 102 and a remote computing device, with data and computation distributed across the devices.

In various embodiments, memory 202 is volatile (such as RAM), nonvolatile (such as ROM, flash memory, etc.) or some combination of the two. As illustrated, memory 202 may include content 104, images 110, capture component 120, evaluation component 122, machine learning model 124, and response component 126. This data and these components are described above in detail with respect to FIG. 1.

In some embodiments, the processor(s) 204 is a central processing unit (CPU), a graphics processing unit (GPU), or both CPU and GPU, or other processing unit or component known in the art.

Computing device 200 also includes additional data storage devices (removable and/or non-removable) such as, for example, magnetic disks, optical disks, or tape. Such additional storage is illustrated in FIG. 2 by removable storage 206 and non-removable storage 208.

Non-transitory computer-readable media may include volatile and nonvolatile, removable and non-removable tangible, physical media implemented in technology for storage of information, such as computer readable instructions, data structures, program modules, or other data. System memory 202, removable storage 206 and non-removable storage 208 are all examples of non-transitory computer-readable media. Non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information and which can be accessed by the computing device 200. Any such non-transitory computer-readable media may be part of the computing device 200.

Computing device 200 also may have input device(s) 210, such as a keyboard, a mouse, a touch-sensitive display, a voice input device (e.g., a microphone), or a camera (e.g., camera 108). Further, the computing device 200 may have output device(s) 212, such as a display, speakers, a printer, etc. These devices are well known in the art and need not be discussed at length here.

Computing device 200 also has one or more network interfaces 214 that allow the computing device 200 to communicate with other computing devices, such as a remote server or access node (not shown) or with computing device 102.

### Example Processes

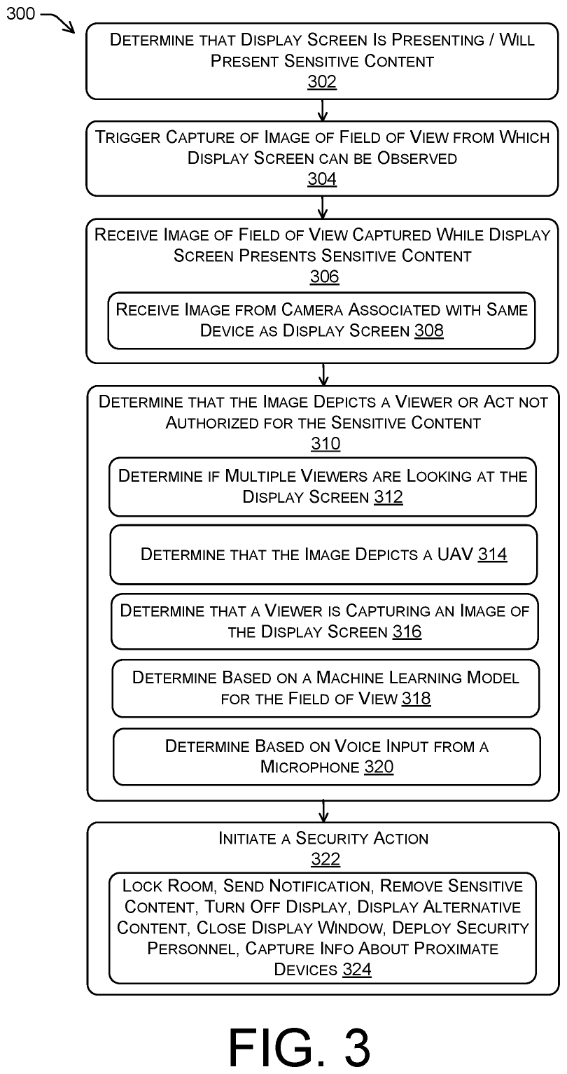

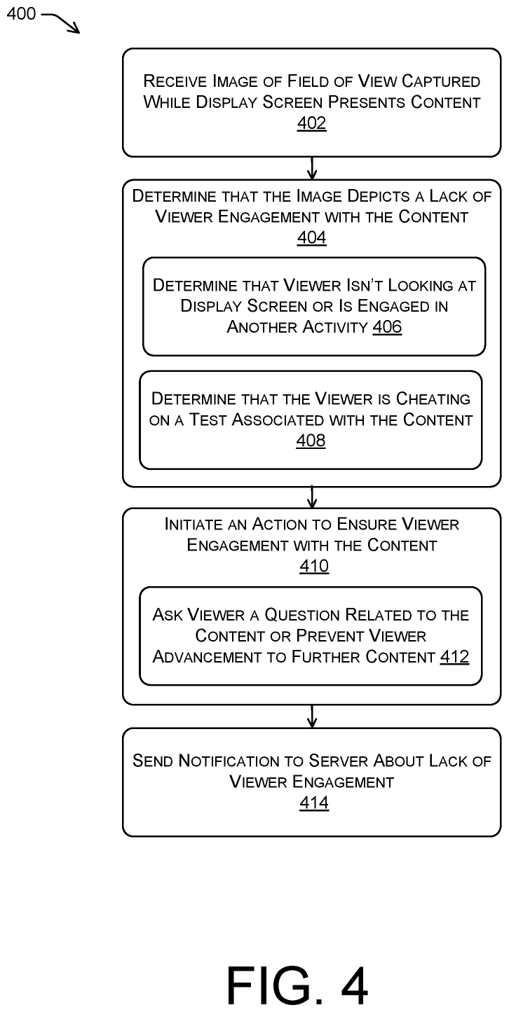

FIGS. 3-4 illustrate example processes. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

FIG. 3 illustrates an example process for determining, based on an image, that an unauthorized viewer has observed sensitive content displayed on a display screen or an unauthorized act has occurred with respect to the sensitive content and, in response, initiating a security action. The process 300 includes, at 302, a computing device determining that a display screen is presenting or will present sensitive content.

At 304, in response to the determining that the display screen is presenting or will present the sensitive content, the computing device triggers capture of an image of a field of view from which a display screen can be observed.

At 306, the computing device receives the image of the field of view. As noted, the image is captured while the display screen presents sensitive content. In some implementations, the receiving includes, at 308, receiving the image from a camera associated with a same computing device as the display screen.

At 310, the computing device then determines that the image depicts a viewer or act not authorized for the sensitive content. At 312, the determining may include determining if multiple viewers are looking at the display screen. At 314, the determining may include determining that the image depicts an unmanned aerial vehicle. At 316, the determining may include determining that a viewer of the display screen is capturing an image of the display screen. At 318, the determining may be based on a machine learning model for the field of view. The machine learning model may be trained based on a corpus of images of authorized viewers, authorized actions, unauthorized viewers, and unauthorized actions. At 320, the determining may be based on voice input from a microphone.

At 322, in response to the determining, the computing device initiates a security action. At 324, the security action may include at least one of locking a room that includes the display screen, sending notification to a provider of the sensitive content or to a monitoring service, removing the sensitive content from the display screen, turning off the display screen, displaying alternative content on the display screen, closing a window displaying the sensitive content, deploying security personnel, or capturing information about other devices in proximity to the display screen.

FIG. 4 illustrates an example process for determining, based on an image, that a viewer is not engaged with displayed content and taking an action to ensure viewer engagement.

The process 400 includes, at 402, a computing device receiving an image of a field of view from which a display screen can be observed. The image may be captured while the display screen presents content.

At 404, the computing device determines that the image depicts a lack of viewer engagement with the content. At 406, the determining comprises determining that a viewer isn't looking at the display screen or is engaged in another activity while content is displayed. At 408, the determining comprises determining whether a viewer is cheating during a test (e.g., when the content is associated with the test).

At 410, in response to the determining, the computing device initiates an action to ensure viewer engagement with the content. At 412, the action is at least one of asking a viewer a question related to the content or preventing a viewer from advancing to further content.

At 414, the computing device may send a notification to a server about the lack of viewer engagement with the content.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

I claim:

1. A computer-implemented method comprising:
receiving an image of a field of view from which a display screen can be observed, the image captured while the display screen presents sensitive content;
determining that the image depicts a viewer or act not authorized for the sensitive content; and
in response to the determining, initiating a security action.

2. The method of claim 1, wherein the receiving comprises receiving the image from a camera associated with a same computing device as the display screen.

3. The method of claim 1, further comprising:
determining that the display screen is presenting or will present the sensitive content; and
in response to the determining that the display screen is presenting or will present the sensitive content, triggering capture of the image.

4. The method of claim 1, wherein the determining comprises determining if multiple viewers are looking at the display screen.

5. The method of claim 1, wherein the determining comprises determining that the image depicts an unmanned aerial vehicle.

6. The method of claim 1, wherein the determining comprises determining that a viewer of the display screen is capturing an image of the display screen.

7. The method of claim 1, wherein the determining is based on a machine learning model for the field of view.

8. The method of claim 7, wherein the machine learning model is trained based on a corpus of images of authorized viewers, authorized actions, unauthorized viewers, and unauthorized actions.

9. The method of claim 1, wherein the determining is further based on voice input from a microphone.

10. The method of claim 1, wherein the security action comprises at least one of locking a room that includes the display screen, sending notification to a provider of the sensitive content or to a monitoring service, removing the sensitive content from the display screen, turning off the display screen, displaying alternative content on the display screen, closing a window displaying the sensitive content, deploying security personnel, or capturing information about other devices in proximity to the display screen.

11. A system comprising:
a processor;
a display screen communicatively coupled to the processor;
a camera configured to capture an image of a field of view from which the display screen can be observed; and
programming instructions configured to be executed by the processor to perform operations including:
receiving the image from the camera, the image captured while the display screen presents sensitive content,
determining that the image depicts a viewer or act not authorized for the sensitive content, and
in response to the determining, initiating a security action.

12. The system of claim 11, wherein the determining comprises one or more of:
determining if multiple viewers are looking at the display screen;
determining that the image depicts an unmanned aerial vehicle; or
determining that a viewer of the display screen is capturing an image of the display screen.

13. The system of claim 11, further comprising a machine learning model for the field of view, wherein the machine learning model is trained based on a corpus of images of authorized viewers, authorized actions, unauthorized viewers, and unauthorized actions.

14. The system of claim 11, wherein the determining includes determining, based on voice input from a microphone, that the image depicts a viewer or act not authorized for the sensitive content.

15. The system of claim 11, wherein the security action comprises at least one of locking a room that includes the display screen, sending notification to a provider of the sensitive content or to a monitoring service, removing the sensitive content from the display screen, turning off the display screen, displaying alternative content on the display screen, closing a window displaying the sensitive content, deploying security personnel, or capturing information about other devices in proximity to the display screen.

16. A non-transitory computer-readable medium having programming instructions stored thereon which, when executed by one or more computing devices, cause the computing device(s) to perform actions comprising:
receiving an image of a field of view from which a display screen can be observed, the image captured while the display screen presents content;
determining that the image depicts a lack of viewer engagement with the content; and
in response to the determining, initiating an action to ensure viewer engagement with the content.

17. The non-transitory computer-readable medium of claim 16, wherein determining the lack of viewer engagement comprises determining that a viewer isn't looking at the display screen or is engaged in another activity while content is displayed.

18. The non-transitory computer-readable medium of claim 16, wherein the content is associated with a test, and the determining the lack of viewer engagement comprises determining whether a viewer is cheating during the test.

19. The non-transitory computer-readable medium of claim 16, wherein the action is at least one of asking a viewer a question related to the content or preventing a viewer from advancing to further content.

20. The non-transitory computer-readable medium of claim 16, wherein the operations further comprise sending a notification to a server about the lack of viewer engagement with the content.
